(19) United States
(12) Patent Application Publication
(10) Pub. No.: US 2003/0015596 A1
(43) Pub. Date: Jan. 23, 2003

(54) Mixing fluid streams

(76) Inventor: Richard O. Evans, Kirkburton (GB)

Correspondence Address: Gary M. Gron, Esquire, Cummins Inc., Mail Code 60701, Box 3005, Columbus, IN, 47202, US

(21) Appl. No.: 10/161,834

(22) Filed: Jun. 4, 2002

(30) Foreign Application Priority Data
Jun. 5, 2001 (GB) 0113735.5

(51) Int. Cl. A62C 5/02

(52) U.S. Cl. 239/8; 239/403; 239/463; 239/468; 60/605.2; 239/433

(57) ABSTRACT

Apparatus for mixing together two fluid streams comprises a first fluid conduit for carrying a first fluid stream between an inlet and an outlet, a venturi being provided in said first fluid conduit between said inlet and said outlet. The venturi comprises an upstream tapering portion which converges towards a reduced diameter throat and a downstream diffusing portion which diverges from the throat towards the outlet. The tapering portion, throat and diffusing portion are defined around a central axis. At least one mixing inlet having a discrete opening communicating with the throat of the venturi is provided for introducing a second fluid stream into the first fluid stream so that the two fluid streams mix as they flow through the venturi diffuser portion towards the outlet. The mixing inlet is configured to direct the second fluid stream into the venturi throat in a direction lying in a plane disposed at an angle between 90° and 45° to the axis, and a direction not more than about 30° to a plane tangential to the venturi throat in the region of the mixing in

### FIELD OF THE INVENTION

The present invention relates to an apparatus and method for mixing together two or more fluid streams into a single stream. Particularly, but not exclusively, the invention relates to mixing gas streams in an exhaust gas re-circulation system of a combustion engine.

### BACKGROUND OF THE INVENTION

It is well known that the emission of nitrogen oxides from an internal combustion engine can be reduced by re-circulating some of the engine exhaust gas to the engine intake. Many such exhaust gas re-circulation (EGR) systems are known. One of the problems encountered in EGR systems is the difficulty of efficiently mixing the re-circulated exhaust gas stream (EGR gas) and intake air stream. This can be particularly problematical in EGR systems incorporated in forced induction engines (such as turbocharged or otherwise supercharged engines) which can create an unfavourable pressure differential between the EGR gas stream and the intake gas stream. For instance, EGR systems are known which include an engine driven EGR pump to raise the pressure of the EGR gas stream for introduction into the engine intake. The use of an EGR pump does however carry the disadvantages of extra cost and weight and also parasitic losses of engine power leading to increased fuel consumption.

EGR systems are known which include a venturi to create a localised pressure depression in the intake air line. Essentially, in such systems the EGR gas is introduced into the throat of a venturi provided in the intake air line which thus reduces the work required to combine the two gas streams. Such an EGR system is disclosed in U.S. Pat. No. 4,426,848.

EGR systems are also known which provide a venturi in the intake air line in combination with an EGR pump. An example of such an EGR system is disclosed in U.S. Pat. No. 5,937,650. This discloses a turbocharged engine in which a turbo-compressor has two vane sets, one which compresses the intake air and one which compresses the EGR gases. The compressor intake and EGR gas streams are then mixed at a venturi provided in the intake air line downstream of the turbocharger. The EGR gases are introduced into the intake air stream via a volute surrounding the throat of the venturi.

U.S. Pat. No. 5,611,203 discloses an EGR system which is intended for high efficiency turbo-charged engines, but which obviates the need for an EGR pump. Essentially, EGR gas is mixed with the main intake gas stream via two EGR passages which converge at a lobed mixer type ejector provided in the intake passageway. The pumping efficiency achieved is said to be about four time that obtainable using a venturi.

In general, whether the EGR system incorporates a pump, a venturi or otherwise, there is a need to mix the EGR gas and intake gas streams with as little pressure loss as possible to maximise engine efficiency. Furthermore, the two gas streams should be well mixed to ensure that an homogenous mixture reaches each engine cylinder. It is therefore an object of the present invention to provide an apparatus and method for mixing together the fluid streams in an exhaust gas re-circulation system with low pressure loss and good mixing. The invention can, however, be applied more widely and thus in more general terms it is an object of the present invention to provide an apparatus and method for efficiently mixing together two or more fluid streams.

### SUMMARY OF THE INVENTION

According to a first aspect of the present invention there is provided an apparatus for mixing together two fluid streams, comprising:

a first fluid conduit for carrying a first fluid stream between an inlet and an outlet;

a venturi provided in said first fluid conduit between said inlet and said outlet, the venturi comprising an upstream tapering portion which converges towards a reduced diameter throat and a downstream diffusing portion which diverges from the throat towards said outlet, the tapering portion, throat and diffusing portion being defined around a central axis;

at least one mixing inlet having a discrete opening communicating with the throat of the venturi for introducing a second fluid stream into said first fluid stream so that the two fluid streams mix as they flow through the venturi diffuser portion towards the outlet;

wherein said mixing inlet is configured to direct said second fluid stream into the venturi throat in a direction lying in a plane disposed at an angle between 90° and 45° to said axis, and a direction not more than about 30° to a plane tangential to the venturi throat in the region of the mixing inlet.

It is to be understood that a “discrete” opening is an opening which is not continuous in any direction and, for instance, excludes annular openings.

Directing the second fluid stream in the direction defined above provides a number of benefits over prior art arrangements. In particular, turbulance, and associated pressure loss, is minimised whilst at the same time a significant swirl component is introduced into the mixed flow with both improves mixing in the venturi diffuser and further helps minimise pressure losses. These effects are discussed in more detail further below.

The second fluid stream is preferably directed at an angle less than about 5° (and most preferably substantially parallel) to said tangential plane.

The second fluid stream is also preferably directed at an angle greater than about 60° to said axis. The greater the angle the greater the swirl induced in the fluid flow. In preferred embodiments the second fluid stream is directed in a direction substantially transverse to said axis.

The or each mixing inlet preferably communicates with the venturi through a respective opening in the wall of the venturi throat which has a circumferential extent of less than ¼ or ⅛ of the circumference of the venturi throat, and preferably as small as is practical to provide the required mixing rate.

In an alternative embodiment of the apparatus the mixing inlet may comprise an arcuate passage extending at least part way around the circumference of the venturi throat and provided with an array of openings spaced apart within said arcuate passage to direct the second fluid stream into the first fluid stream at different locations around at least said part of the circumference of the venturi throat.

It will be appreciated that the apparatus according to the invention can be used in a variety of applications where it is required to mix two or more fluid streams (more than two streams could be mixed together by providing two or more mixing inlets each receiving a different fluid). However, the invention is particularly applicable to the mixing of re-circulated exhaust gas with the intake gas stream of an internal combustion engine in an otherwise conventional exhaust gas re-circulation system. In such an embodiment the first fluid conduit, and venturi, will be disposed in an air intake line of the engine and said mixing inlet will be connected to the engine exhaust to deliver re-circulated exhaust gas to the throat of the venturi.

The invention also provides a method of mixing together two fluid streams (for instance the air intake and exhaust re-circulation streams of an exhaust re-circulation system), the method comprising:

flowing a first fluid stream through a first fluid conduit provided with a venturi having an upstream tapering portion which converges towards a reduced diameter throat and a downstream diffusing portion which diverges from the throat towards an outlet;

introducing a second fluid stream into the first fluid stream through a discrete opening in the region of the venturi throat so that two streams mix within the venturi diffuser portion as they flow together towards said outlet;

wherein the second fluid stream is directed into the first fluid stream in a direction lying in a plane disposed at an angle between 90° and 45° to the direction of flow of the first fluid stream through the venturi, and a direction not more than about 30° to a plane tangential to the venturi throat in the region where the two fluid streams meet.

### BRIEF DESCRIPTION OF THE DRAWINGS

Specific embodiments of the present invention will now be described, by way of example only, with reference to the accompanying drawings, in which:

FIG. 1 is a schematic illustration of a turbocharged engine and EGR system including a venturi;

FIG. 2 is a schematic perspective view of a venturi arrangement in accordance with a first embodiment of the present invention which may be incorporated in the EGR system depicted in FIG. 1;

FIG. 3 is a cross-section through the throat of the venturi arrangement of FIG. 2;

FIG. 4 illustrates the gas mixing achieved in the venturi of FIGS. 2 and 3; and

FIGS. 5 to 8 are schematic cross-sectioned illustrations of four alternative embodiments of the present invention.

### DETAILED DESCRIPTION OF THE PREFERRED EMBODIMENTS

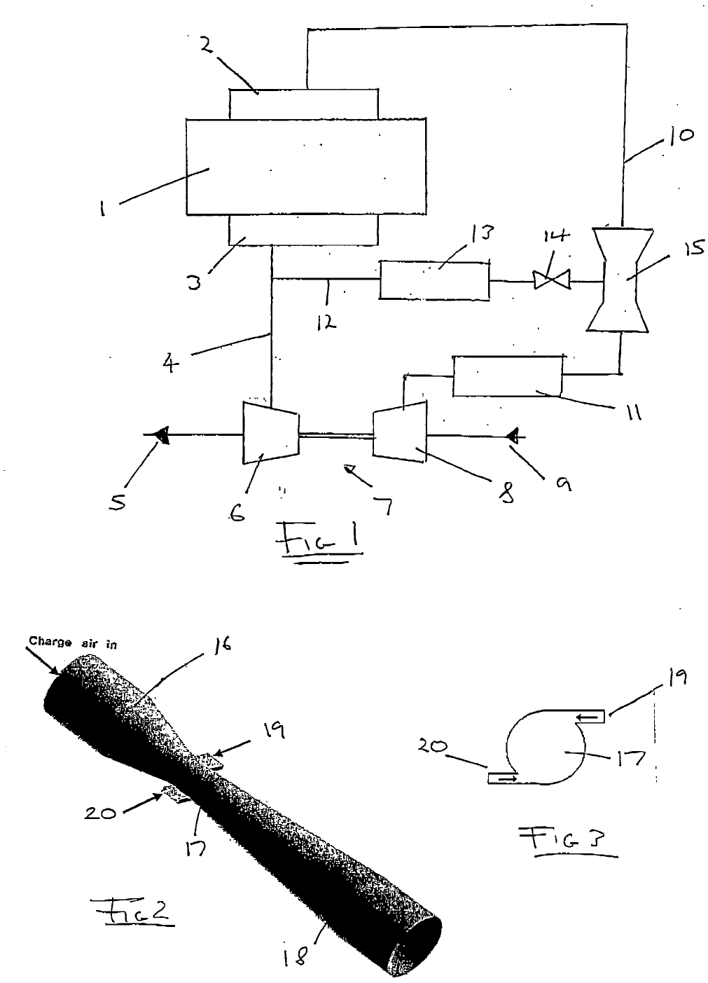

Referring to the drawings, FIG. 1 shows an internal combustion engine 1 having an intake manifold 2 and an exhaust manifold 3. A main exhaust line 4 carries exhaust gas from the exhaust manifold to an exhaust outlet 5 via a turbine 6 of a turbocharger 7. The turbocharger compressor 8 is driven by turbine 6 to compress intake air received from an inlet 9 and deliver it to the intake manifold 2 through intake line 10 via an aftercooler 11.

The EGR system comprises an EGR gas line 12 which takes exhaust from the exhaust manifold 3 (or main exhaust gas line 4 as shown) and delivers this to the intake air line 10 via an EGR cooler 13 and EGR control valve 14. The EGR gas stream is introduced into the intake air stream at the throat of a venturi 15 provided in the intake air line 10.

The engine and EGR system described above in relation to FIG. 1 is only one example of the basic components of a typical system. The present invention lies in the particular manner in which the EGR gas stream is mixed with the intake gas stream at the venturi 15.

A first embodiment of venturi 15 according to the present invention is illustrated schematically in FIGS. 2 and 3. This shows a venturi comprising an upstream section 16 tapering towards a throat 17 and a downstream diffuser section 18. As intake air flows through the venturi the intake air pressure drops as the flow is accelerated in the upstream tapering section 16, reaching a minimum pressure at the venturi throat 17, and then increases again as the gas slows in the downstream diffuser section 19. A localised pressure depression is therefore created in the intake air flow at the venturi throat 18.

The EGR gas is introduced into the intake gas stream at the throat 18 of the venturi through two diametrically opposed EGR gas inlet passages 19 and 20. The EGR gas inlet passages 19 and 20 are arranged to direct the EGR gas into the venturi in a direction transverse to the main intake gas flow direction and tangential to the venturi throat 17 (each inlet 19 and 20 directing the EGR gas in the same circumferential direction). The tangential EGR gas flow introduces a swirling component into the combined gas stream flowing through the venturi diffuser 18. This is illustrated in FIG. 4.

Introducing the EGR gas tangentially to the main intake flow provides several benefits. Relatively high sheer stresses occur where the EGR gas and intake gas streams two flows meet which encourages thorough mixing. Mixing is also improved in the diffuser section 18 of the venturi 15 due to the effective increase in the gas flow path length resulting from the swirling motion.

An additional benefit of the swirl is an improvement in the diffusion of the combined gas flow. In the absence of any significant swirl component there is a tendency for the flow to separate from the wall of the diffuser section 18 with resultant pressure losses in the intake gas stream delivered to the engine. However, the centripetal force generated by the swirl induces the flow to adhere to the diffuser wall improving the diffusion process and thus minimising pressure losses. Tests on the present invention have shown that inducing a sheer component of between 8° to 16° in the flow in a conical diffuser is sufficient to significantly improve the diffusion process compared to a flow with no swirl component.

In the embodiment of the invention illustrated in FIGS. 2 and 3 the EGR gas inlet passages 19 and 20 have a flat rectangular configuration to enhance the tangential nature of the EGR gas introduced into the venturi throat 17. It will be appreciated, however, that other inlet configurations could be used, including simple tubular pipes. Indeed, the inlet passages need not necessarily themselves be tangential to the provided they direct the EGR gas flow tangentially to the main intake flow.

Although it is preferred that the EGR gas flow is at least substantially tangential to the venturi 15, the EGR gas flow could have a radial component (relative to the axis of the venturi) and still provide benefits over prior art arrangements. A deviation of less than 5° from a tangential direction is preferred although larger deviations, up to about 30° from a tangential direction, may still give satisfactory results.

Similarly, the EGR gas flow need not be exactly transverse to the main intake gas flow through the venturi but could have an axial component (again relative to the axis of the venturi). Any such axial component will reduce the swirl effect but an angle up to about 45° may nevertheless induce sufficient swirl to provide significant improvement over prior art arrangements.

It will also be appreciated that modifications may be made to the exact form of the venturi 15. For instance, the angle of the tapering section 16 and the angle of the diffusing section 18 may vary, as may the length of the throat 17. Such modifications will be readily apparent to the appropriately skilled person.

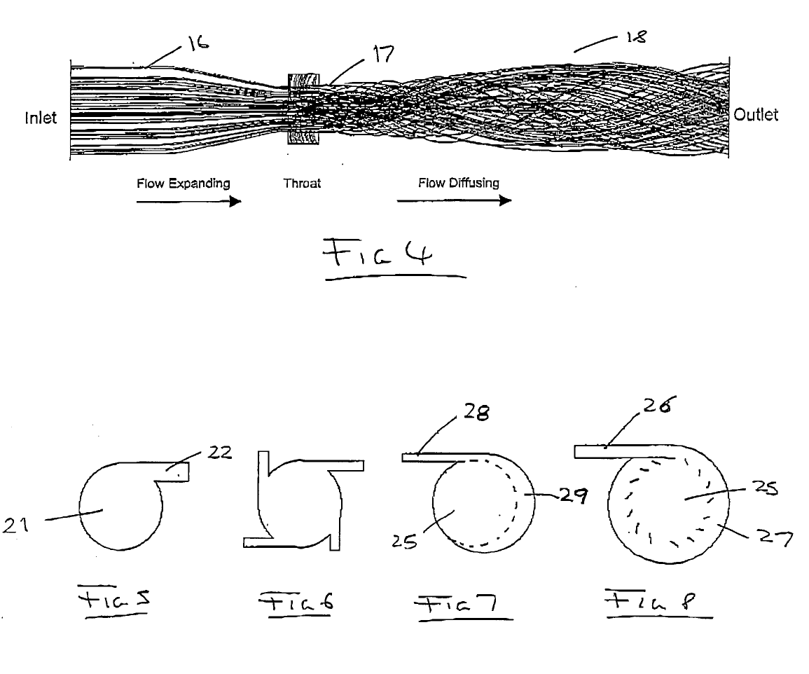

It will also be understood that more or less than 2 EGR gas inlets may be provided. A number of alternative embodiments of the invention having different numbers and forms of EGR gas inlet are illustrated in FIGS. 5 to 8.

FIG. 5 illustrates a cross-section through a venturi throat 21 provided with a single tangential EGR gas inlet 22. One disadvantage with this arrangement compared with the two inlet arrangement of FIGS. 3 and 4 is that asymmetries can be introduced into the gas flow with resultant separation of the combined gas flow from the diffuser walls reducing the beneficial effects of the swirl induced in the gas flow. Accordingly, it is preferred to have a plurality of EGR gas inlets at diametrically opposed positions. For instance, an embodiment having four such inlets in two diametrically opposed pairs is illustrated in FIG. 6.

FIG. 7 shows a cross-section through a venturi throat 25 provided with an EGR gas inlet comprising a tangential portion 26 and an annular portion 27 which surrounds the venturi throat 25. The annular portion 27 is provided with a circumferential array of nozzles each angle to direct EGR gas in a direction generally tangential to the venturi throat. A variation of this arrangement is illustrated in FIG. 8. In the arrangement of FIG. 8 the EGR inlet comprises a tangential portion 28 and an arcuate portion 29 partially surrounding the venturi throat 30 and provided with a series of nozzles 31 to direct the EGR gas tangentially to the venturi throat.

Although the application of the invention described above is in an exhaust gas re-circulation system it will be understood that the invention can be applied more widely. That is, the invention may have utility in any application requiring the efficient mixing of fluid streams, both gases and liquids, for instance in chemical process industries. In such applications the invention may be used to mix more than two different fluid flows. For instance, an embodiment corresponding to FIG. 7 could be used to mix five different fluid streams into a single flow.

Having thus described the invention what is novel and desired to be secured by Letters Patent of the United States is:

1. Apparatus for mixing together two fluid streams, comprising:
a first fluid conduit for carrying a first fluid stream between an inlet and an outlet;
a venturi provided in said first fluid conduit between said inlet and said outlet, the venturi comprising an upstream tapering portion which converges towards a reduced diameter throat and a downstream diffusing portion which diverges from the throat towards said outlet, the tapering portion, throat and diffusing portion being defined around a central axis;
at least one mixing inlet having a discrete opening communicating with the throat of the venturi for introducing a second fluid stream into said first fluid stream so that the two fluid streams mix as they flow through the venturi diffuser portion towards the outlet;
wherein said mixing inlet is configured to direct said second fluid stream into the venturi throat in a direction lying in a plane disposed at an angle between 90° and 45° to said axis, and a direction not more than about 30° to a plane tangential to the venturi throat in the region of the mixing inlet.

2. Apparatus according to claim 1, wherein said second fluid stream is directed at an angle less than about 5° to said tangential plane.

3. Apparatus according to claim 2, wherein the second fluid flow is directed substantially parallel to said tangential plane.

4. Apparatus according to claim 1, wherein said second fluid stream is directed at an angle greater than about 60° to said axis.

5. Apparatus according to claim 4, wherein the second fluid stream is directed at an angle greater than about 85° to said axis.

6. Apparatus according to claim 5, wherein the second fluid stream is directed in a direction substantially transverse to said axis.

7. Apparatus according to claim 1, wherein each mixing inlet communicates with the venturi through a respective opening in the wall of the venturi throat which has a circumferential extent of less than ¼ of the circumference of the venturi throat.

8. Apparatus according to claim 7, wherein each mixing inlet communicates with the venturi through a respective opening in the wall of the venturi throat which has a circumferential extent of less than ⅛ of the circumference of the venturi throat.

9. Apparatus according to claim 1, wherein each mixing inlet communicates with the venturi through an opening in the wall of the venturi throat which has an axial dimension greater than its circumferential dimension.

10. Apparatus according to claim 1, comprising at least one pair of said mixing inlets communicating with the venturi throat at diametrically opposed locations.

11. Apparatus according to claim 10, comprising two pairs of mixing inlets equispaced around the circumference of the venturi throat.

12. Apparatus according to claim 1, wherein each mixing inlet comprises a substantially straight tubular section communicating with an opening in the wall of the venturi throat.

13. Apparatus according to claim 1, wherein the mixing inlet comprises an arcuate passage extending at least part way around the circumference of the venturi throat and provided with an array of discrete openings spaced apart within said arcuate passage to direct the second fluid stream into the first fluid stream at different locations around at least said part of the circumference of the venturi throat.

14. Apparatus according to claim 13, comprising an array of vanes disposed in said arcuate passage directing the second fluid stream through openings defined between circumferentially adjacent vanes.

15. An exhaust gas re-circulation system for an internal combustion engine, comprising: a first fluid conduit for carrying an intake air stream between an air inlet and an outlet supplying air to said internal combustion engine;
a venturi provided in said first fluid conduit between said inlet and said outlet, the venturi comprising an upstream tapering portion which converges towards a reduced diameter throat and a downstream diffusing portion which diverges from the throat towards said outlet, the tapering portion, throat and diffusing portion being defined around a central axis;
at least one mixing inlet having a discrete opening communicating with the throat of the venturi for introducing exhaust from said internal combustion engine into said intake air so that the two fluid streams mix as they flow through the venturi diffuser portion towards the outlet;
wherein said mixing inlet is configured to direct said second fluid stream into the venturi throat in a direction lying in a plane disposed at an angle between 90° and 45° to said axis, and a direction not more than about 30° to a plane tangential to the venturi throat in the region of the mixing inlet.

16. A method of mixing together two fluid streams, the method comprising:
flowing a first fluid stream through a first fluid conduit provided with a venturi having an upstream tapering portion which converges towards a reduced diameter throat and a downstream diffusing portion which diverges from the throat towards an outlet;
introducing a second fluid stream into the first fluid stream through a discrete opening in the region of the venturi throat so that two streams mix within the venturi diffuser portion as they flow together towards said outlet;
wherein the second fluid stream is directed into the first fluid stream in a direction lying in a plane disposed at an angle between 90° and 45° to the direction of flow of the first fluid stream through the venturi, and a direction not more than about 30° to a plane tangential to the venturi throat in the region where the two fluid streams meet.

17. A method according to claim 16 wherein said first stream is the air intake stream of an internal combustion engine and said second stream is an exhaust gas stream in an internal combustion engine exhaust gas re-circulation system.

18. A method according to claim 17 wherein said exhaust gas stream is introduced into the air intake stream through at least two mixing inlets.
